(19) United States
(12) Patent Application Publication
(10) Pub. No.: US 2017/0293440 A1
(43) Pub. Date: Oct. 12, 2017

(54) STORAGE DEVICE AND DATA SAVING METHOD IN THE SAME

(71) Applicant: KABUSHIKI KAISHA TOSHIBA, Tokyo (JP)

(72) Inventor: Hiroyoshi SAITO, Ome Tokyo (JP)

(21) Appl. No.: 15/394,347

(22) Filed: Dec. 29, 2016

Related U.S. Application Data
(60) Provisional application No. 62/319,674, filed on Apr. 7, 2016.

(51) Int. Cl. G06F 3/06; G06F 12/0802

(52) U.S. Cl. CPC G06F 3/0619; G06F 3/0647; G06F 3/0685; G06F 12/0802; G06F 2212/1032; G06F 2212/60

(57) ABSTRACT

A storage device includes a nonvolatile storage medium, a volatile memory, a plurality of nonvolatile memories, each of which has a lower access latency than the nonvolatile storage medium, and a controller circuitry. The controller circuitry is configured to store, temporarily in the volatile memory, write data to be written in the nonvolatile storage medium, and in response to an interruption of power supplied to the storage device from an external power source, select target nonvolatile memories to be accessed, from the plurality of nonvolatile memories, in an order determined based on a busy state of each of the plurality of nonvolatile memories, and save a different portion of the write data stored in the volatile memory into the selected target volatile memories, respectively.

### CROSS-REFERENCE TO RELATED APPLICATIONS

This application claims the benefit of U.S. Provisional Application No. 62/319,674, filed Apr. 7, 2016, the entire contents of which are incorporated herein by reference.

### FIELD

Embodiments described herein relate generally to a storage device and a data saving method in the same.

### BACKGROUND

In general, a storage device, such as a magnetic disk device or a solid-state drive (SSD), includes a cache in order to increase a speed of access from a host system (host). The cache is used for temporarily storing data (write data) specified by a write command from the host, and data read from the disk in accordance with a read command from the host.

In general, a volatile memory is used for the cache. For that reason, data (namely, cache data) stored in the cache is lost when power supplied to the magnetic disk device is interrupted

In order to avoid loss of cache data due to the interruption of power, that is, in order to protect cache data from the power interruption, various methods have been proposed. One of the methods is saving cache data in a nonvolatile memory, such as flash ROM, using a backup power source upon occurrence of the power interruption. A cache-data protection function according to this method is also called as a power loss protection (PLP) function.

However, even if the PLP function is used, the backup power source may not provide sufficient time to save all cache data in the nonvolatile memory. In view of this, it would be desirable to shorten the time period required to save the cache data upon power interruption.

### BRIEF DESCRIPTION OF THE DRAWINGS

FIG. 1 is a block diagram of a magnetic disk device according to an embodiment.

FIG. 2 illustrates a memory map of cache data stored in a cache in the magnetic disk device shown in FIG. 1.

FIG. 3 illustrates a data structure of a save management table in the magnetic disk device shown in FIG. 1.

FIG. 4 illustrates a data structure of a defect management table of the magnetic disk device shown in FIG. 1.

FIG. 5 is a flowchart showing a procedure of data save processing carried out in the embodiment.

FIG. 6 is a flowchart showing a procedure of first save processing carried out during the data save processing.

FIG. 7 is a flowchart showing a procedure of second save processing carried out during the data save processing.

FIG. 8 illustrates flash ROMs (FROMs) to explain switching of target flash ROMs (FROMSs) and data saving in a target FROM performed during the data save processing.

FIG. 9 illustrates content of the save management table saved in an FROM during the data save processing.

FIG. 10 is a flowchart showing a procedure of data recovery processing carried out in the embodiment.

### DETAILED DESCRIPTION

Various embodiments will be described hereinafter with reference to the accompanying drawings.

In general, according to an embodiment, a storage device includes a nonvolatile storage medium, a volatile memory, a plurality of nonvolatile memories, each of which has a lower access latency (e.g., read/write latency) than the nonvolatile storage medium, and a controller circuitry. The controller circuitry is configured to store, temporarily in the volatile memory, write data to be written in the nonvolatile storage medium, and in response to an interruption of power supplied to the storage device from an external power source, select target nonvolatile memories to be accessed, from the plurality of nonvolatile memories, in an order determined based on a busy state of each of the plurality of nonvolatile memories, and save a different portion of the write data stored in the volatile memory into the selected target volatile memories, respectively.

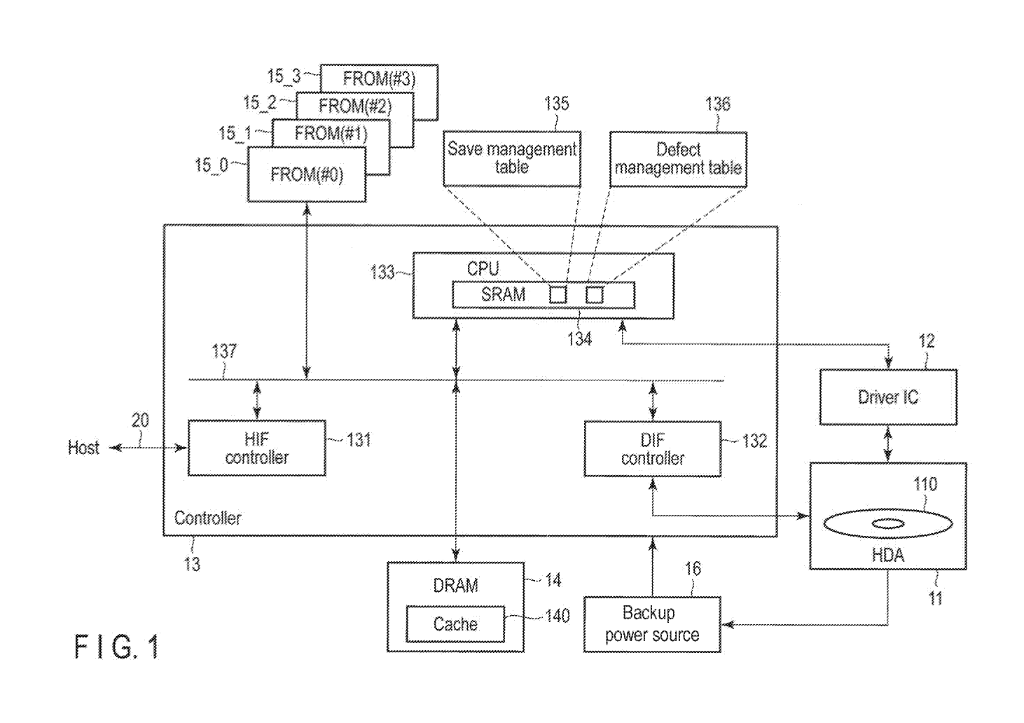

FIG. 1 is a block diagram of a magnetic disk device (hereinafter, referred to also as a hard disk drive (HDD]) according to an embodiment. The magnetic disk device is an example of a storage device. The HDD shown in FIG. 1 comprises a head disk assembly (HDA) 11, a driver IC 12, a controller 13, a DRAM 14, a plurality of flash ROMs (FROMs) (for example, four FROMs 15_0 to 15_3), and a backup power source 16.

The HDA 11 includes a disk 110. The disk 110 is, for example, a nonvolatile storage medium that has at least one surface serving as a recording surface on which data are magnetically recorded. The HDA 11 further includes known mechanical elements, such as a head, a spindle motor (SPM), and an actuator. However, these elements are omitted in FIG. 1.

The driver IC 12 drives the SPM and the actuator under control of the controller 13 (more specifically, a CPU 133 included in the controller 13). The controller 13 is formed of, for example, a large-scale integrated circuit (LSI) that comprises a plurality of elements integrated on a single chip and is called as a system-on-a-chip (SOC). The controller 13 includes a host interface controller (hereinafter, referred to as an HIF controller) 131, a disk interface controller (hereinafter, referred to as a DIF controller) 132, and the CPU 133.

The HIF controller 131 is connected to a host device (hereinafter, referred to as host) through a host interface 20. The HIF controller 131 receives commands (a write command, a read command, etc.) from the host. The HIF controller 131 controls data transfer between the host and the DRAM 14.

The DIF controller 132 controls data transfer between the disk 110 and the DRAM 14. The DIF controller 132 includes a read/write channel (not shown). The read/write channel processes signals associated with, for example, read/write operations with respect to the disk 110. The read/write channel converts a signal (read signal) read from the disk 110 into digital data, using an analog-to-digital converter, and decodes read data from the digital data. Further, the read/write channel extracts, from the digital data, servo data required for head positioning. The read/write channel encodes write data to be written to the disk 110. The read/write channel may be provided independently of the DIF controller 132. In this case, it is sufficient that the DIF controller 132 controls data transfer between the DRAM 14 and the read/write channel.

The CPU 133 is a processor that functions as a main controller of the HDD shown in FIG. 1, and includes, for example, an SRAM 134. However, the SRAM 134 may be provided outside the CPU 133 or the controller 13. The CPU 133 controls at least a part of the other elements of the HDD in accordance with a control program. The part of the other elements includes the driver IC 12, the HIF controller 131, and the DIF controller 132.

In the present embodiment, the control program is pre-stored in a particular storage area of an FROM (not shown) (hereinafter, referred to as a particular FROM) different from the FROMs 15_0 to 15_3. Alternatively, the control program may be pre-stored in one of the FROMs 15_0 to 15_3, the disk 110, or a nonvolatile read-only memory (not shown), such as a ROM. An initial program loader (IPL) is also pre-stored in a part of the storage area of the particular FROM.

The CPU 133 loads at least a part of the control program to a part of the storage area of the SRAM 134 (or the DRAM 14) by, for example, executing the IPL in accordance with start of power supply to the HDD from a main power source external to the HDD. However, when the control program is stored in the particular FROM as in the present embodiment, the above-described program loading may not be performed. Moreover, the IPL may be pre-stored in, for example, a ROM.

The SRAM 134 is a volatile memory that can operate at a higher access speed than the DRAM 14. A part of the storage area of the SRAM 134 is used for storing a save management table 135 and a defect management table 136 for the target flash ROMs. Alternatively, the tables 135 and 136 may be stored in the DRAM 14. That is, the DRAM 14 may be used in place of the SRAM 134, to store the tables 135 and 136 in addition to the control program.

A part of the storage area of the DRAM 14 is used as a cache 140. The cache 140 is a cache (a so-called write cache) to store write data transferred from the host (namely, write data specified by a write command from the host). Another part of the storage area of the DRAM 14 is used as a cache (a so-called read cache) to store read data that are read from the disk 110. In FIG. 1, the read cache is omitted.

The FROMs 15_0 to 15_3 are rewritable nonvolatile memories that can be accessed at a speed faster than the disk 110. The FROMs 15_0 to 15_3 are used by the CPU 133 mainly to save data (cache data) stored in the cache 140 of the DRAM 14 upon interruption of power supply (power interruption) to the HDD from the main power source, for example. The DRAM 14 and the FROMs 15_0 to 15_3 may be provided in the controller 13.

Each of the FROMs 15_0 to 15_3 includes a status register (not shown). Each of the status registers indicates at least a busy/ready status and a write result status associated with a corresponding FROM. The busy/ready status indicates whether or not the corresponding FROM is currently being accessed (that is, the FROM is busy, such that a new access, such as writing of data, is impossible), or it is not accessed (that is, it is ready, such that a new access, such as writing of data, is possible). The write result status indicates the result (existence/nonexistence of an error) of a new write operation with respect to the corresponding FROM.

The backup power supply 16 temporarily generates power in accordance with the power interruption. The generated power is used for saving data stored in the cache 140 into any of FROMs 15_0 to 15_3. In the present embodiment, the generated power is also used for retracting the head to a position (ramp) that is separate from the disk 110.

The HIF controller 131, the DIF controller 132, the CPU 133, the DRAM 14, and the FROMs 15_0 to 15_3 are connected to a bus 137. The bus 137 includes a data bus and an address bus. In the present embodiment, to save cache data in the FROMs 15_0 to 15_3, the CPU 133 uses the bus 137 in a time-division manner, and sequentially accesses one of the FROMs 15_0 to 15_3. In such a way, in an environment in which the FROMs 15_0 to 15_3 cannot simultaneously be accessed, the CPU 133 performs processing of saving data in the FROMs 15_0 to 15_3 in parallel. The FROMs 15_0 to 15_3 may be connected to the CPU 133 directly or through the HIF controller 131 without using the bus 137.

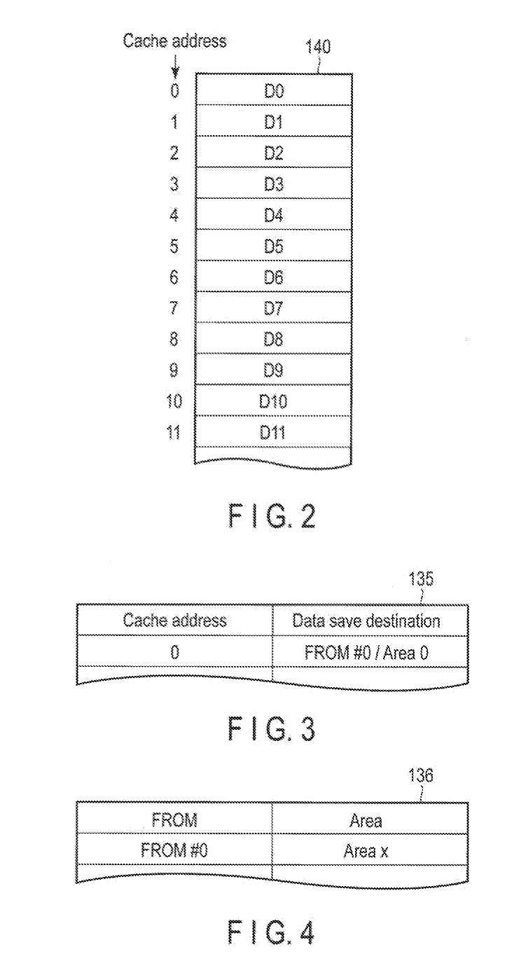

FIG. 2 shows a memory map of cache data stored in the cache 140 shown in FIG. 1. In FIG. 2, data (cache data) D0 to D11 are stored in areas of the cache 140 denoted by cache addresses 0 to 11, respectively. The cache address represents a relative address in the storage area of the DRAM 14 that includes the cache 140. The respective areas of the cache 140 specified by the cache addresses 0 to 11 are areas of a certain size called blocks, and the size of each of data DO to D11 is also equal to the size of the block.

FIG. 3 shows a data structure of the save management table 135 shown in FIG. 1. The save management table 135 is used for managing a save destination of each cache data in association with a corresponding cache address. That is, the save management table 135 is used for storing data (FROM #q/Area r[q]) that indicates the save destination of data Dp (D[p]) in association with cache address p in the cache 140. FROM #q (q is one of 0 to 3) corresponds to the FROM 15_q, and Area r[q] indicates the r[q]-th area (block) in the FROM 15_q. In the description below, the FROMs 15_0 to 15_3 may be expressed as FROMs #0 to #3, respectively.

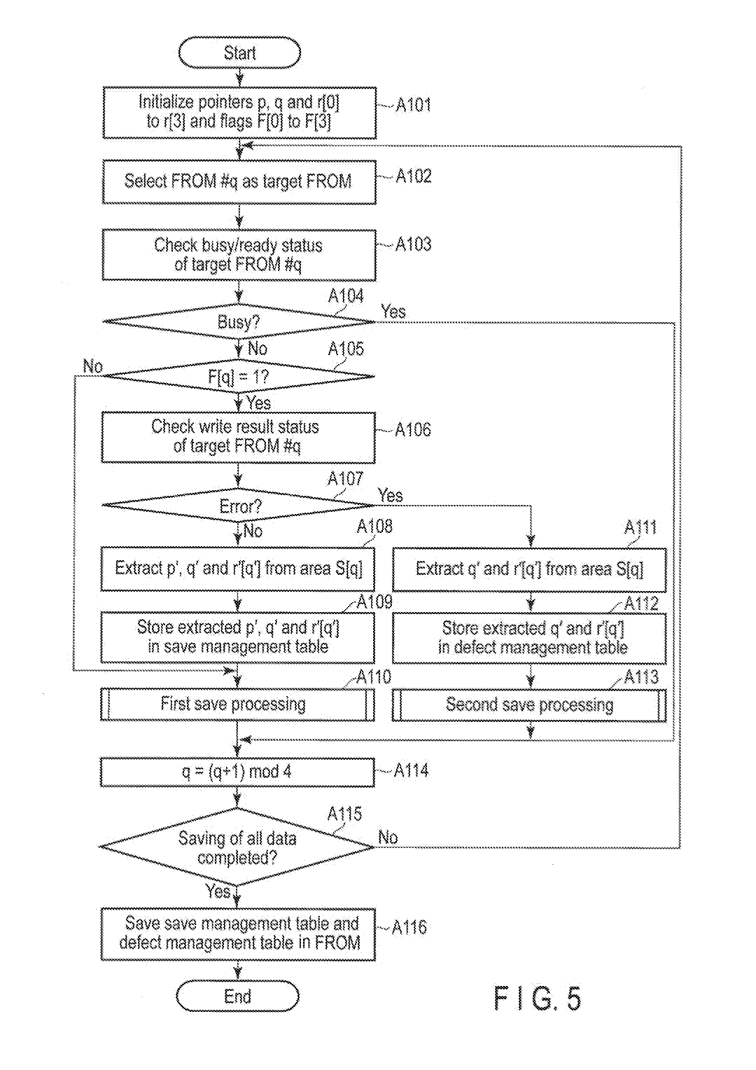

FIG. 4 shows a data structure of the defect management table 136 for target flash ROMs shown in FIG. 1. The defect management table 136 is used for managing defective areas in the FROMs 15_0 to 15_3. That is, the defect management table 136 is used for storing data indicating area r[q] of FROM #q that is determined to be defective, in association with data q that indicates FROM #q.

Referring then to FIG. 5, data save processing for saving cache data in a nonvolatile memory, using a power loss protection (PLP) function, will be described. FIG. 5 is a flowchart showing a procedure of the data save processing.

The CPU 133 monitors a power supply state of power from the main power source to the HDD. The CPU 133 determines that the interruption of power supply (namely, power interruption) occurred when a power supply voltage applied to the HDD is less than a certain level (namely, a threshold) for more than a certain period. In this case, the CPU 133 activates the PLP function. At this time, the backup power supply 16 generates power. In the present embodiment, the backup power supply 16 uses a back electromotive force of the SPM to generate power. Alternatively, the backup power supply 16 may generate power using a capacitor charged with the power supply voltage applied to the HDD.

The power generated by the backup power supply 16 is supplied at least to the driver IC 12, the controller 13, the DRAM 14, and the FROMs 15_0 to 15_3 of the HDD. However, in FIG. 1, paths for supplying power from the backup power supply 16 to the driver IC 12, the DRAM 14, and the FROMs 15_0 to 15_3 are omitted.

Upon receiving power from the backup power supply 16, the CPU 133 starts the data save processing in accordance with the flowchart of FIG. 5. First, the CPU 133 initializes pointers p, q, and r[0] to r[3], and flags F[0] to F[3] (A101). That is, the CPU 133 sets pointers p, q, and r[0] to r[3] to initial values, respectively, and clears flags F[0] to F[3].

Pointer p indicates a cache address assigned to an area of the cache 140 of the DRAM 14 that stores to-be-saved cache data (more specifically, write cache data). The data stored in the area of the cache 140 corresponding to pointer p (namely, cache address p) will be expressed by D[p] (or Dp). The initial value of pointer p indicates the cache address of an area of the cache 140, which stores data D[p] to be saved first in the data save processing. In the present embodiment, it is assumed that the initial value of pointer p is 0.

Pointer q indicates an FROM where data D[q] is to be saved, i.e., FROM #q (FROM 15_q). In the present embodiment, it is assumed that the initial value of pointer q is 0.

Pointer r[q] (q=0, 1, 2, 3) indicates an area in FROM #q, where data D[p] is saved. In the present embodiment, the initial value of pointer r[q] is 0.

If flag F[q] is set, it indicates that at least one operation for saving data to FROM #q has been performed during the data save processing. In contrast, if flag F[q] is cleared, it indicates that no operation for saving data on FROM #q has been performed during the data save processing. That is, if flag F[q] is set, it indicates that a data save operation, which will now be performed, is other than the first operation of saving data on FROM #q. Further, if flag F[q] is cleared, it indicates that a data save operation, which will now be performed, is the first operation of saving data on FROM #q. In the description below, the state where flag F[q] is set may be expressed as F[q]=1, and the state where flag F[q] is cleared may be expressed as F[q]=0.

Next, the CPU 133 selects FROM #q indicated by pointer q as an FROM (hereinafter, referred to as a target FROM) in which data (cache data) D[p] indicated by pointer p is to be saved (A102). Subsequently, the CPU 133 refers to the status register of target FROM #q via the bus 137, thereby checking the busy/ready status of the target FROM #q (A103). After that, the CPU 133 determines whether target FROM #q is busy (A104).

If target FROM #q is not busy (No in A104), i.e., if target FROM #q is ready, the CPU 133 determines that a data save operation for saving (writing) data D[p] in area r[q] of target FROM #q is possible. At this time, the CPU 133 determines whether or not flag F[q] is set (that is, whether or not F[q]=1 is met) (A105). If it is determined that flag F[q] is set (Yes in A105), the CPU 133 determines that a data save operation, which will now be performed, is other than the first operation of saving data on target FROM #q. Further, since target FROM #q is ready (No in A104), the CPU 133 determines that the last data save operation on FROM #q has been completed. In this case, the status register of target FROM #q indicates, as a write result status, the result of the last data save (write) operation on FROM #q.

After that, the CPU 133 refers to the status register of target FROM #q, thereby checking the write result status (A106). Based on the write result status, the CPU 133 determines whether or not the result of the last write operation on FROM #q is an error (A107).

If it is determined that the result of the last write operation is not an error (No in A107), i.e., if the last data save operation on FROM #q has been completed with no errors, the process proceeds to A108. At this time, data associated with the last data save operation on FROM #q is set in particular area S[q] in the SRAM 134 (or the DRAM 14), as will be analogized from a description below. This data includes p′, q′, and r′[q′] equivalent to p, q, and r[q], respectively, used in the last data save operation on FROM #q.

In A108, the CPU 133 extracts a combination of p′, q′, and r′[q′] from area S[q]. The CPU 133 stores, in the save management table 135 in the SRAM 134, the extracted combination of p′, q′, and r′[q′] as save management data associated with the last data save operation on FROM #q indicated by current pointer p (namely, FROM #q′ indicated by extracted q′) (A109).

In the present embodiment, it is assumed that the content of all entries of the save management table 135 is cleared (initialized) in A101. Further, in the present embodiment, it is assumed that the extracted combination of p′, q′, and r′[q′] is stored in an entry of the save management table 135 associated with p′ (A109). In this case, only q′ and r′[q′] included in the combination of p′, q′, and r′[q′] may be stored in the entry of the save management table 135 associated with p′. That is, the save management data may not include p′ (cache address) associated with the entry of the save management table 135 in which the save management data is stored. Alternatively, unlike the present embodiment, the entries of the save management table 135 may be sequentially used for storing the combination of p′, q′, and r′[q′], in order beginning with the leading one.

Stored save management data p′, q′, and r′[q′] indicate that data D[p′] stored in an area of the cache 140 corresponding to cache address p′ has been saved in area r′[q′] of FROM #q′. After executing A109, the CPU 133 executes first save processing for saving (writing) data D[p] in area r[q] of target FROM #q (A110).

In contrast, if it is determined that the result of the last write operation on FROM #q is an error (Yes in A107), the CPU 133 extracts q′ and r′[q′] from area S[q] (A111). Subsequently, the CPU 133 stores (adds), in the defect management table 136 in the SRAM 134, the extracted combination of q′ and r′[q′] as defect management data indicating that area r′[q′] in FROM #q′ is defective (A112). After that, the CPU 133 executes second save processing for retrying the last data save operation on FROM #q indicated by current pointer p (namely, FROM #q′ indicated by extracted q′) (A113).

Moreover, if it is determined that flag F[q] is not set, i.e., F[q]=0 (No in A105), the CPU 133 determines that a data save operation, which will now be performed, is the first data save operation on target FROM #q. In this case, the CPU 133 skips A106 to A109, and performs the first save processing (A110).

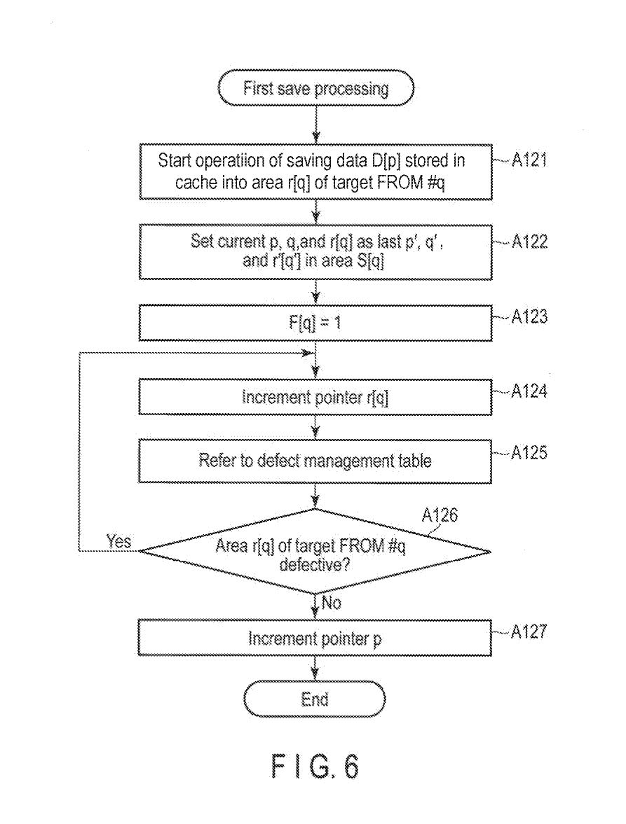

Referring now to FIG. 6, the first save processing (A110) will be described. FIG. 6 is a flowchart showing a procedure of the first save processing. First, the CPU 133 reads data D[p] in the cache 140, which corresponds to current pointer p, and starts an operation of saving read data D[p] in area r[q] of target FROM #q corresponding to current pointers p and r[q] (A121). In this case, target FROM #q shifts to a busy state.

Next, the CPU 133 sets the combination of current pointers p, q, and r[q] as the combination of last pointers p′, q′, and r′[q′] in area S[q] in the SRAM 134 (or the DRAM 14) (A122). After that, the CPU 133 sets current flag F[q] regardless of the state of flag F[q] (A123). At this time, the CPU 133 may set flag F[q] only when flag F[q] is cleared (that is, No in A105). Alternatively, only in this case, the CPU 133 may set flag F[q] during steps between A105 and A110.

Next, the CPU 133 increments pointer r[q] by, for example, 1 (A124). Incremented pointer r[q] indicates an area subsequent to the current area of target FROM #q.

Next, based on current pointers q and r[q], the CPU 133 refers to the defect management table 136 in the SRAM 134 (A125). After that, the CPU 133 determines whether or not area r[q] of target FROM #q, which correspond to pointers q and r[q], is defective (A126).

If it is determined that the area is defective (Yes in A126), the process returns to A124, where pointer r[q] is incremented again. Incremented pointer r[q] indicates an area subsequent to an area determined to be defective of target FROM #q.

In contrast, if it is determined that area r[q] of target FROM #q is not defective (No in A126), the CPU 133 increments pointer p so that pointer p indicates an area in the cache 140 where data to be saved next is stored (A127). At this time, the CPU 133 finishes the first save processing (A110 in FIG. 5) according to the flowchart of FIG. 6.

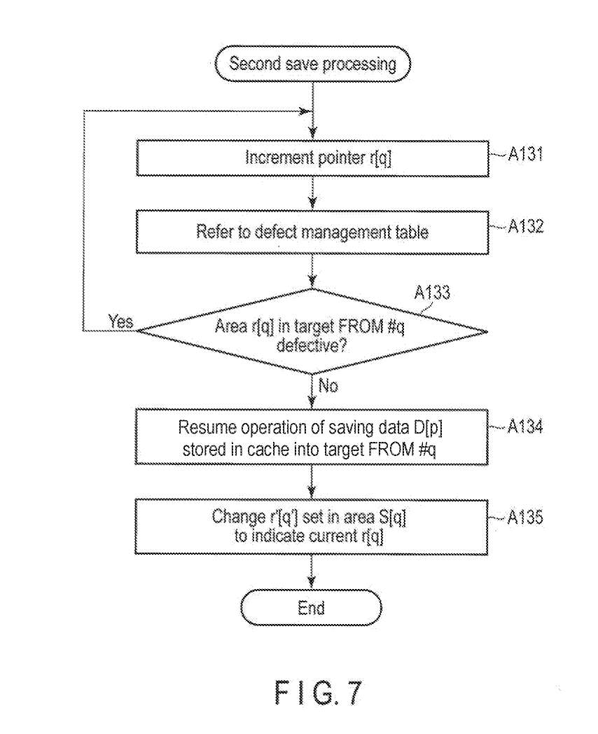

Referring next to FIG. 7, the second save processing (A113 in FIG. 5) will be described. FIG. 7 is a flowchart showing a procedure of the second save processing. First, the CPU 133 increments pointer r[q] by, for example, 1 (A131). Incremented pointer r[q] indicates an area subsequent to an area (namely, an area determined to be defective) in target FROM #q, where an error has been detected in A107 (in FIG. 5) that is performed immediately before the second save processing.

Next, based on current pointers q and r[q], the CPU 133 refers to the defect management table 136 in the SRAM 134 (A132). After that, the CPU 133 determines whether or not area r[q] of target FROM #q, which corresponds to pointers q and r[q], is defective (A133).

If it is determined that the area is defective (Yes in A133), the process returns to A131, where pointer r[q] is incremented again. Incremented pointer r[q] indicates an area subsequent to an area determined to be defective in target FROM #q.

In contrast, if it is determined that area r[q] target FROM #q is not defective (No in A133), the CPU 133 resumes an operation of saving data D[p] in the cache 140, indicated by current pointer p, to target FROM #q indicated by current pointer q (A134). That is, the CPU 133 retries a data save operation on FROM #q (=q′) where saving of data D[p] has failed.

Current pointers p and q indicate data D[p] and an FROM as a save destination for data D[p], respectively, which have been used for an operation of saving data determined to be erroneous in the most recent A107 of FIG. 5. In contrast, an area in target FROM #q, where data D[p] has been saved in A134, is an area indicated by pointer r[q] incremented at least once in A131 of the second save processing. This area in target FROM #q was determined not to be defective in A133 immediately before A134, and differs from the area determined to be defective based on the determination of an error in the most recent A107 in FIG. 5.

After executing A134, the CPU 133 changes r′[q′], set in area S[q], to current r[q] (A135). At this time, the CPU 133 finishes the second save processing (A113 in FIG. 5) according to the flowchart of FIG. 7.

The flowchart of FIG. 5 will be referred to again. After executing the first save processing (A110), the process proceeds to A114 for preparation of switching the target FROM. Also after execution of the second save processing (A113), the process proceeds to A114.

In contrast, if it is determined that target FROM #q is busy (Yes in A104), the CPU 133 determines that the last data save operation on FROM #q has not yet been completed, since latency of FROM #q is long. In this case, if the CPU 133 waits for target FROM #q becoming ready after the completion of the last data save operation on FROM #q, its operation of saving data D[p] would be delayed. In consideration of this point, in the present embodiment, the CPU 133 does not wait for target FROM #q becoming ready.

That is, the CPU 133 determines that the target FROM (namely, an FROM to which data D[p] is to be saved) is to be switched from current FROM #q to a subsequent FROM by skipping processing of saving data to FROM #q. Then, the process proceeds to A114 for preparation of switching the target FROM. The FROM subsequent to FROM #q is FROM #q+1 if FROM #q is one of FROMs #0 to #2, and if FROM #q is FROM #3, the subsequent FROM is FROM #0, as will be described below.

In A114, the CPU 133 updates pointer q to (q+1) mod 4 so that pointer q indicates an FROM subsequent to current target FROM #q. The term (q+1) mod 4 represents a residue obtained when q+1 is divided by 4. Therefore, if pointer q is 0, 1, or 2, pointer q is incremented by 1. If pointer q is 3, pointer q is set to 0. That is, pointer q cyclically indicates FROMs #0 to #3.

Next, the CPU 133 determines whether or not saving of all data (cache data) in the cache 140, which is to be saved, has been completed (A115). If it is determined that saving of all data is not completed (No in A115), the process returns to A102. That is, the CPU 133 iterates the above-mentioned processing until saving of all data is completed, while cyclically checking the statuses (busy/ready statuses) of FROMs #0 to #3. This processing includes skipping (A114, A115, and A102) a step using FROM #q to save data, when FROM #q selected in A102 is busy (Yes in A104). In the description below, the skipping of the step of using an FROM (FROM #q) to save data may also be referred to as skipping of the FROM, to simplify the description.

If it is determined that saving of all data is completed (Yes in A115), the CPU 133 saves, to one (e.g., FROM #0) of FROMs #0 to #3, the save management table 135 and the defect management table 136 in the SRAM 134 (or the DRAM 14) (A116). At this time, the CPU 133 finishes the data save processing according to the flowchart of FIG. 5. The save management table 135 and the defect management table 136 saved in FROM #0 are loaded for use into the SRAM 134 (or the DRAM 14) at subsequent power-on of the HDD.

Here, the save management table 135 may be saved in one of FROMs #0 to the #3, and the defect management table 136 may be saved in another one of FROMs #0 to #3. Alternatively, the save management table 135 and the defect management table 136 may be saved to an FROM different from FROMs #0 to #3.

According to the present embodiment, during the data save processing according to the flowchart of FIG. 5, FROMs #0 to #3 are cyclically selected as a target FROM for saving cache-data (A114 and A102). However, if the latency of the target FROM is long, the last data save operation on the target FROM has not been completed, and hence the target FROM is busy (Yes in A104), the CPU 133 does not wait for completion of the last data save operation. That is, the CPU 133 skips the target FROM and selects, as a new target FROM, an FROM subsequent to the target FROM (A114 and A102).

If the new target FROM can be accessed with a shorter latency, a last data save operation on the new target FROM has been completed, and the new target FROM is ready (No in A104). In this case, the CPU 133 can immediately start a new data save operation on the new target FROM (A110). As a result, according to the present embodiment, the time required for save operations associated with all FROMs #0 to #3 can be shortened.

Moreover, in the data save processing according to the flowchart of FIG. 5, if the CPU 133 has detected completion of a data save (write) operation on area r′[q′] in FROM #q′ (=q), the CPU 133 checks the result of the operation (A106). If the result indicates an error (Yes in A107), the CPU 133 stores, in the defect management table 136, defect management data indicating that area r′[q′] in FROM #q′ is defective (A111 and A112).

According to the present embodiment, when, for example, the data save operation shown in the flowchart of FIG. 5 is performed again, the CPU 133 can avoid a defective area by referring to the defect management table 136 (A124 to A126 in FIGS. 6 and A131 to A133 in FIG. 7). That is, according to the present embodiment, since area r[q] in target FROM #q, where data are to be saved, can be freely set, the FROM can be used efficiently, while avoiding use of a defective block.

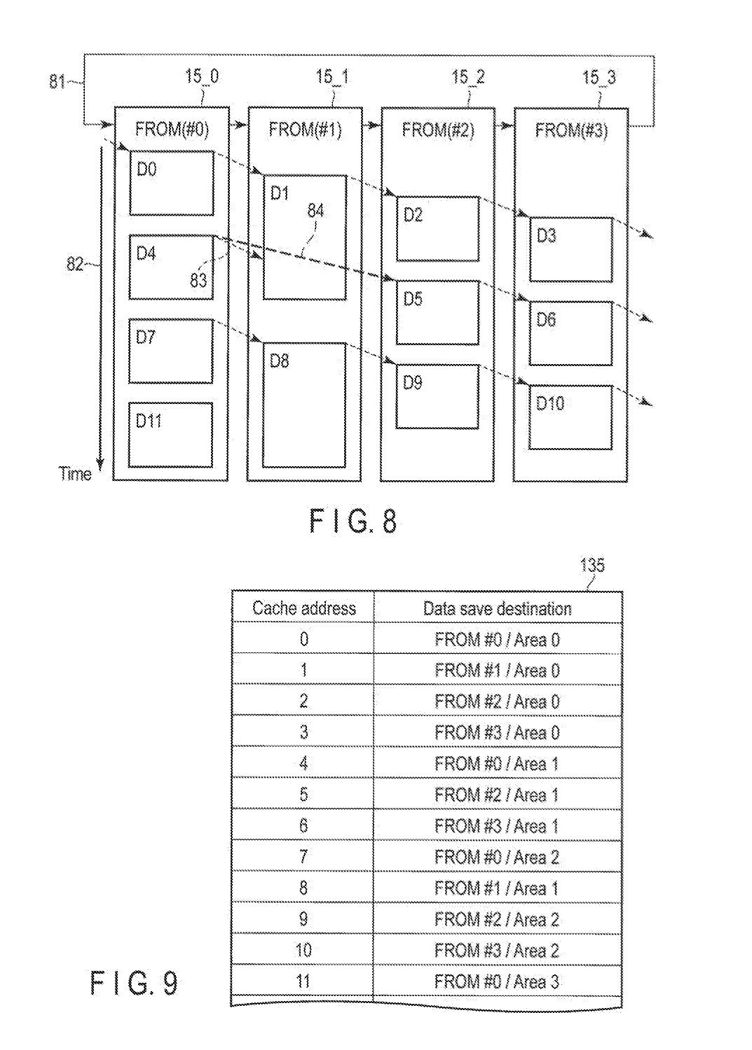

Referring now to FIG. 8 in addition to FIGS. 2, 5, and 6, a specific example of the above-described data save processing will be described. FIG. 8 illustrates FROMs the #0 to #3 to explain switching of a target FROM and data saving in a target FROM.

FROMs #0 (15_0) to #3 (15_3) are shown in FIG. 8. In FIG. 8, a group 81 of arrows links FROMs #0 to #3 indicates that the FROM designated as a data save destination (target) by pointer q is cyclically switched in order of FROM #0→FROM #1→FROM #2→FROM #3→FROM #0→FROM #1→FROM #2→FROM #3→FROM #0 → . . .

In the present embodiment, it is assumed that latencies of FROMs #0 to #3 are different from each other (e.g., write speed), although they satisfy predetermined standards associated with the specifications of the HDD. In FIG. 8, it is assumed that the write speed of FROM #1 is half the write speed of the other FROMs #0, #2, and #3. That is, it is assumed that the latency of FROM #1 is longer than those of the other FROMs, and the time required for FROM #1 to write data is twice the time required for the other FROMs to write data.

Further, in the present embodiment, for simplifying the description, it is assumed that areas r[0] to r[3] in each of FROMs #0 to #3 are not defective, and no errors will occur in data save operations on FROMs #0 to #3. Also, it is assumed that all data of the cache 140 shown in FIG. 2 is to be saved during the data save processing. The data to be saved include data DO (D[0]) to D11 (D[11]). In this case, pointer p is set to an initial value of 0 in A101 of FIG. 5, and is then incremented (in this case, incremented by 1) in A127 of FIG. 6 each time saving of data Dp (=D[p]) is started (A121 in FIG. 6). Thus, in the cache 140 shown in FIG. 2, pointer p sequentially indicates data D0, D1, D2, . . . , as data to be saved.

In FIG. 8, an arrow 82 indicates time elapsed after the data save processing is started. In FIG. 8, FROMs #0 to #3 and data D0 to D11 are shown using rectangles. Data D0, D4, D7, and D11, respectively, are located in FROM #0, and data D1 and D8 are located in FROM #1. This means that during the data save processing, data D0, D4, D7, and D11 are saved in FROM #0, and data D1 and D8 are saved in FROM #1.

Data D2, D5, and D9 are located in FROM #2, and data D3, D6, and D10 are located in FROM #3. This means that during the data save processing, data D2, D5, and D9 are saved in FROM #2, and data D3, D6, and D10 are saved in FROM #3. Moreover, the length of the sides of the rectangles representing data items D0 to D11, which are parallel to arrow 82, indicates a time required to save (write) each of data D0 to D11.

When the data save processing shown in the flowchart of FIG. 5 starts, the CPU 133 first selects FROM #0 as the save destination of data DO in the cache 140 (A102). After that, the CPU 133 determines whether or not the selected FROM #0 (target FROM#0) is busy by checking (A103) the busy/ready status of FROM #0 (A104). In FIG. 8, the dashed-line arrow pointing data DO indicates this determination. Similarly, the dashed-line arrows pointing data D1 to D11 in FIG. 8 indicate determination as to whether or not FROMs (target FROMs) selected as the save destinations of data D1 to D11 are busy. Here, it is assumed that the dashed-line arrows extending from the rectangles that represent data D3, D6, and D10 indicate data D4, D7, and D11, respectively.

At the start of the data save processing, FROM #0 is ready (No in A104). At this time, other FROMs #1 to #3 are also ready. When FROM #0 is ready, the CPU 133 starts an operation of saving data DO in area r[0] (=0) of FROM #0 by performing the first data storage processing (A110) in accordance with the flowchart of FIG. 6 (A121).

After that, in the same way as the above-described saving of data D0, the CPU 133 sequentially starts operations of saving data D1 to D3 in areas 0 (r[1]=r[2]=r[3]=0) of FROMs #1 to #3 that are ready, as is shown in FIG. 8 (A121 of FIG. 6).

Subsequently, the process returns to A102 of FIG. 5, and the CPU 133 selects FROM #0 as the save destination of subsequent data D4 in the cache 140 and determines whether or not FROM #0 is busy (A104). At this time, the last data save operation on FROM #0, i.e., the operation of saving data DO in FROM #0, has already been completed as shown in FIG. 8. Therefore, FROM #0 is ready (No in A104). It is assumed here that no errors have occurred during the operation of saving data DO in FROM #0 (No in A107). In this case, the CPU 133 stores, as save management data, the combination of p′=0, q′=0 and r′[q′]=0, which indicates saving of data D0 in area 0 of FROM #0, is stored in an entry of the save management table 135 associated with p′=0 (A108 and A109).

Subsequently, the CPU 133 starts an operation of saving data D4 in area r[0] (=1) of FROM #0 by performing the first data save processing (A110) in accordance with the flowchart of FIG. 6 (A121). After that, the process returns to A102 of FIG. 5, and the CPU 133 selects FROM #1 as the save destination of subsequent data D5 in the cache 140. After that, the CPU 133 determines whether or not FROM #1 is busy, as indicated by dashed-line arrow 83 in FIG. 8 (A104). As described above, the time required for writing of data in FROM #1 is twice the time required for writing of data in the other FROMs. Accordingly, the last data save operation on FROM #1, i.e., the operation of saving data D1 in FROM #1, is uncompleted and is being continued as shown in FIG. 8. That is, FROM #1 is busy (Yes in A104).

In this case, the CPU 133 skips FROM #1. Then, the process returns to A102, and the CPU 133 selects FROM #2 subsequent to FROM #1 as the save destination of data D5 in the cache 140.

The CPU 133 determines whether or not FROM #2 is busy, as is indicated by dashed-line arrow 84 in FIG. 8 (A104). At this time, the last data save operation on FROM #2, i.e., the operation of saving data D2 in FROM #2, has already been completed as shown in FIG. 8. Therefore, FROM #2 is ready (No in A104). It is assumed here that no errors have occurred during the operation of saving data D2 (No in A107).

In this case, the CPU 133 stores, in an entry of the save management table 135 associated with p′=2, the combination of p′=2, q′=2 and r′[q′]=0, which indicates saving of data D2 in area 0 of FROM #2 (A108 and A109). Subsequently, the CPU 133 starts an operation of saving data D5 to area r[2] (=1) of FROM #2 by performing the first data save processing (A110) in accordance with the flowchart of FIG. 6 (A121).

As described above, the latency of FROM #1 is longer than that of the other FROMs. It is assumed here that the CPU 133 does not shift the save destination of data D5 from FROM #1 to FROM #2, and starts an operation of saving data D5 in FROM #1 immediately after completion of operation of saving data D1 in FROM #1. In this case, the start of saving data D5 would be delayed, compared to the present embodiment (shown in FIG. 8).

That is, if saving of cache data in FROMs #0 to #3 is cyclically executed even though latency of FROM #1 is long, this operation will cause a delay in the whole save operation associated with FROMs #0 to #3. In this case, all cache data may not be saved in FROMs #0 to #3 within a backup enabled period.

In the present embodiment, however, if much time is required for saving data in FROM #1 and hence subsequent data cannot be saved in FROM #1, the CPU 133 switches the save destination of the subsequent data from FROM #1 to FROM #2. That is, the CPU 133 skips FROM #1, thereby adjusting the order of use of FROMs #0 to #3 for saving data. This operation shortens the time required for the whole save operation associated with FROMs #0 to #3.

After that, the process returns to A102 of FIG. 5, and the CPU 133 selects FROM #3, subsequent to FROM #2, as the save destination of subsequent data D6 in the cache 140. At this time, the last data save operation on FROM #3, i.e., the operation of saving data D3 in area 0 of FROM #3, has been completed as shown in FIG. 8. Therefore, FROM #3 is ready (No in A104). Further, it is assumed here that no errors have occurred during the operation of saving data D3 (No in A107).

In this case, the CPU 133 stores, as save management data in an entry of the save management table 135 associated with p′=3, the combination of p′=3, q′=3, and r′[q′]=0 that indicates saving of data D3 in area 0 of FROM #3 is stored (A108 and A109). After that, the CPU 133 sequentially selects target FROMs (A102), and each time the CPU 133 confirms that a last data save operation on one of the sequentially selected target FROMs has been normally completed (No in A104 and A107), the CPU 133 stores, in the save management table 135, save management data associated with the last data save operation (A108 and A109). Specific examples of this processing will not be described.

After carrying out A108 and A109, the CPU 133 starts an operation of saving data D6 in area r[3] (=1) of FROM #3 by performing the first data save processing (A110) in accordance with the flowchart of FIG. 6 (A121). After that, the CPU 133 sequentially starts operations of saving data D7, D8, D9, and D10 in area 2 (r[0]=2) of FROM #0, area 1 (r[1]=1) of FROM #1, area 2 (r[2]=2) of FROM #2, and area 2 (r[3]=2) of FROM #3, respectively, as is shown in FIG. 8 (A121).

When the operation of saving data D10 in FROM #3 is started, the operation of saving data D7 in FROM #0 has already been completed. Therefore, the CPU 133 starts an operation of saving data D11 in area r[0] (=3) of FROM #0 subsequent to FROM #3 (A121). At this time, the operation of saving data D8 in FROM #1 subsequent to FROM #0 has not yet been completed as shown in FIG. 8. In contrast, the operation of saving data D9 in FROM #2 subsequent to FROM #1 has already been completed as shown in FIG. 8.

It is assumed here that the cache 140 includes data (for example, data D12) to be saved subsequently to data D11. In this case, the CPU 133 skips FROM #1 and starts an operation of saving data D11 in FROM #2.

When all data in the cache 140, which are to be saved, has been saved (Yes in A115 of FIG. 5), the CPU 133 saves, in, for example, FROM #0, the save management table 135 and the defect management table 136 in the SRAM 134 (or the DRAM 14) (A116). FIG. 9 shows content of the save management table 135 at this time. The content of the save management table 135 shown in FIG. 9 corresponds to the data saving shown in FIG. 8.

In FIG. 8, the time required for writing data in FROM #1 is twice the time required for writing data in the other FROMs. Only data D1 and D8 included in data DO to D11 are saved to FROM #1 of such long latency. In contrast, data D0, D4, D7, and D11 are saved in an FROM other than FROM #1, for example, FROM #0. That is, amount of data saved in FROM #0 is twice that of data saved in FROM #1. This means that the order of use of FROMs #0 to #3 for saving cache data is appropriately adjusted in accordance with the latencies of FROMs #0 to #3. In other words, FROMs #0 to #3 are efficiently selected and accessed. In FIG. 8, the time required for saving cache data in FROMs #0 to #3 can be shortened by about 30%, compared to the case where after certain data have been saved to an FROM (especially, FROM #1), an operation of saving subsequent data is started.

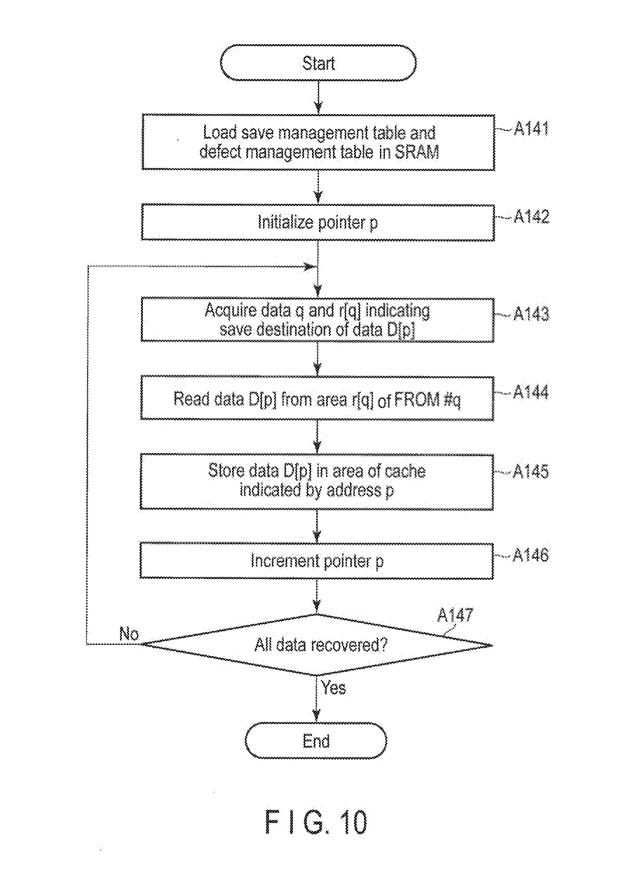

Referring next to FIG. 10, data recovery processing executed upon power-on of the HDD will be described. FIG. 10 is a flowchart showing a procedure of the data recovery processing. It is assumed here that the supply of power to the HDD is resumed after the above-described data save processing was performed upon the power interruption. At this time, the CPU 133 performs the data recovery processing in accordance with the flowchart of FIG. 10.

First, the CPU 133 loads, to the SRAM 134 (or the DRAM 14), the save management table 135 and the defect management table 136 that were saved in FROM #0 through the most recent data save processing (A141). Next, the CPU 133 initializes pointer p (A142). Unlike the data save processing, pointer p indicates a cache address in the cache 140 in the DRAM 14, where data D[p] read from one of FROMs #0 to #3 is to be stored. In the present embodiment, the initial value of pointer p used for the data recovery processing is 0.

Next, the CPU 133 acquires data q and r[q], associated with cache address p indicated by pointer p, from the save management table 135 loaded to the SRAM 134 (or the DRAM 14) (A143). Acquired data q and r[q] represent area r[q] of FROM #q (FROM #q/area r[q]) where data D[p] are saved. The combination of pointer p and acquired data q and r[q] corresponds to the combination of p′, q′, and r′[q′] stored in the save management table 135 in A109 of FIG. 5.

Based on acquired data q and r[q], the CPU 133 reads data D[p] from area r[q] of FROM #q (A144). The CPU 133 stores read data D[p] in an area in the cache 140, which is indicated by pointer p (cache address p) (A145). Thus, the content of the area in the cache 140 indicated by cache address p is recovered to the state immediately before the most recent power interruption.

Next, the CPU 133 increments pointer p so that pointer p indicates a cache address where data are to be stored subsequently (A146). Subsequently, the CPU 133 determines whether or not all data saved in FROMs #0 to #3 has been recovered to the cache 140 (A147). In the present embodiment, the determination in A147 is performed based on whether or not incremented pointer p exceeds a maximum p (=pmax) stored in the save management table 135.

If the result of the determination in A147 is No, the process returns to A143, and the CPU 133 starts an operation of recovering subsequent data D[p] to the cache 140. If all data saved in FROMs #0 to #3 have been recovered (Yes in A147), the CPU 133 finishes the data recovery processing according to the flowchart of FIG. 10.

In the save management table 135 shown in FIG. 9, data DO to D11 are recovered to the cache 140 of the DRAM 14 through the above-described data recovery processing, as shown in FIG. 2. That is, in the present embodiment, although the order of saving of cache data in FROMs #0 to #3 is dynamically changed, the saved cache data can be reliably recovered to the cache 140 based on the save management table 135.

The above embodiments assume that the storage device is an HDD. However, the storage device may be a semiconductor drive unit, such as an SSD, which has a nonvolatile storage medium including a group of nonvolatile memories (for example, NAND memories).

According to at least one embodiment described above, the time required for saving cache data can be shortened.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device, comprising:
a nonvolatile storage medium;
a volatile memory;
a plurality of nonvolatile memories, each of which has a lower access latency than the nonvolatile storage medium; and
a controller circuitry configured to
store, temporarily in the volatile memory, write data to be written in the nonvolatile storage medium, and
in response to an interruption of power supplied to the storage device from an external power source, select target nonvolatile memories to be accessed, from the plurality of nonvolatile memories, in an order determined based on a busy state of each of the plurality of nonvolatile memories, and save a different portion of the write data stored in the volatile memory into the selected target nonvolatile memories, respectively.

2. The storage device according to claim 1, wherein
the controller circuitry periodically selects the target nonvolatile memories from the plurality of nonvolatile memories, while skipping any of the nonvolatile memories in the busy state.

3. The storage device according to claim 1, further comprising:
an internal power source, wherein
the controller circuitry carries out saving of the write data into the nonvolatile memories using power supplied from the internal power source.

4. The storage device according to claim 1, wherein
the controller circuitry is further configured to
maintain correspondence between a region of the volatile memory in which a portion of the write data was stored and an address of the nonvolatile memories in which the portion of the write data is saved, and
save the correspondence in one of the nonvolatile memories after completion of saving the write data.

5. The storage device according to claim 4, wherein
the controller circuitry is further configured to load the saved correspondence into the volatile memory, in response to restart of power supply from the external power source.

6. The storage device according to claim 5, wherein
the controller circuitry is further configured to store the saved portions of write data in regions of the volatile memory in which the saved portions were originally stored, respectively, by referring to the loaded correspondence.

7. The storage device according to claim 1, wherein
the controller circuitry is further configured to sequentially select a target region of the target nonvolatile memory while skipping one or more regions of the target nonvolatile memory in a defective state, to save the portion of the write data in the selected target region of the target nonvolatile memory.

8. The storage device according to claim 7, wherein
the controller circuitry is further configured to
maintain defect management data indicating one or more defective regions in each of the nonvolatile memories, and
save the defect management data in one of the nonvolatile memories in addition to the write data.

9. The storage device according to claim 8, wherein
the controller circuitry is further configured to load the saved defect management data into the volatile memory, in response to restart of power supply from the external power source.

10. The storage device according to claim 1, wherein
the controller circuitry accesses the selected target nonvolatile memories in the determined order and in parallel.

11. The storage device according to claim 1, wherein
a data writing speed of one of the nonvolatile memories is different from a data writing speed of another one of the nonvolatile memories.

12. A method of saving data in a storage device including a nonvolatile storage medium, a volatile memory, and a plurality of nonvolatile memories, each of which has a lower access latency than the nonvolatile storage medium, the method comprising:
detecting an interruption of power supplied to the storage device from an external power source;
in response to the detection of the interruption of power, selecting target nonvolatile memories to be accessed, from the plurality of nonvolatile memories, in an order determined based on a busy state of each of the plurality of nonvolatile memories; and
saving a different portion of write data that are temporarily stored in the volatile memory and to be written in the nonvolatile storage medium, into the selected target nonvolatile memories, respectively.

13. The method according to claim 12, wherein
the target nonvolatile memories are selected periodically from the plurality of nonvolatile memories, while skipping any of the nonvolatile memories in the busy state.

14. The method according to claim 12, wherein
the saving is carried out using power supplied from an internal power source of the storage device.

15. The method according to claim 12, further comprising:
maintaining correspondence between a region of the volatile memory in which a portion of the write data was stored and an address of the nonvolatile memories in which the portion of the write data is saved; and
saving the correspondence in one of the nonvolatile memories after completion of saving the write data.

16. The method according to claim 15, further comprising:
loading the saved correspondence into the volatile memory of the storage device, in response to restart of power supply from the external power source.

17. The method according to claim 16, further comprising:
storing the saved portions of write data in regions of the volatile memory in which the saved portions were originally stored, respectively, by referring to the loaded correspondence.

18. The method according to claim 12, further comprising:
sequentially selecting a target region of the target nonvolatile memory while skipping one or more regions of the target nonvolatile memory in a defective state, to save the portion of the write data in the selected target region of the target nonvolatile memory.

19. The method according to claim 18, further comprising:
maintaining defect management data indicating one or more defective regions in each of the nonvolatile memories, and
saving the defect management data in one of the nonvolatile memories in addition to the write data.

20. The method according to claim 19, further comprising:
loading the saved defect management data into the volatile memory of the storage device, in response to restart of power supply from the external power source.
